(19) United States
(12) Patent Application Publication
(10) Pub. No.: US 2010/0173267 A1
(43) Pub. Date: Jul. 8, 2010

(54) Method for producing restorative tooth preparation and treatment compositions and product

(75) Inventors: Densen Cao, Sandy, UT (US); Steven Jensen, South Jordan, UT (US)

Correspondence Address: CAO Group, Inc., 4628 W. Skyhawk Drive, West Jordan, UT, 84084, US

(73) Assignee: CAO Group, Inc., West Jordan, UT (US)

(21) Appl. No.: 12/319,455

(22) Filed: Jan. 6, 2009

(51) Int. Cl. A61C 5/04

(52) U.S. Cl. 433/228.1

(57) ABSTRACT

An improved product and method for production of a restorative tooth preparation and treatment composition that combines select organic acids and glutaraldehydes as a means to disinfect, desensitize, and etch in a single step that requires no rinsing.

### BACKGROUND OF THE INVENTION

1. Field of Invention

The present invention relates to product compositions and methods to produce tooth surface compositions that assist in the preparation and treatment of teeth during the restorative process. More particularly it provides a product composition and method for producing a combination composition of select organic acids and glutaraldehyde in a solvent as a means to disinfect, desensitize, and etch in a single step.

2. Objective of the Invention

It is the objective of this invention to provide new and novel tooth surface compositions to shorten the time in the preparation and treatment of teeth during the restorative process. These novel compositions specifically cover the process of etching, disinfection and root desensitizing prior to final restoration incorporating all 3 functions in a single application system without rinsing in order to facilitate ease of use by medical, veterinarian and dental practitioners.

3. State of the Art

There is a need in dentistry for various materials and methods for restoring teeth after a loss of tooth structure by decay, accidents, and wear. These include many materials such as composites, adhesives, porcelain and metal prosthetics and many other contemporary dental restorative materials.

Current methods of restoration usually include

1. Surface preparation steps

2. Adhesive step

3. Filling with restorative material

4. Adjusting and polishing.

For example to fill a common carious lesion a dentist will physically remove the decay by pneumatic drill and hand tools, followed by preparing the surface for the application of adhesive. The surface preparation usually includes a phosphoric acid etch which chemically removes the damaged layer caused by the pneumatic drill and hand tools. This damaged layer is called the smear layer. Removing the smear layer allows increased penetration and contact of the adhesive to the tooth surface for better bonding strengths. Some dentists may in a second and third step apply a chemical desensitizer followed by a disinfectant after the etching step. The desensitizing step is intended to nullify any exposed nerve endings in the tooth in order to relieve any post-operative pain. Some dentists like this step in order to avoid patient callbacks complaining of pain and sensitivity. The disinfection step is desired to ultimately wipeout any residual bacterial caries not seen by the practitioner but is nevertheless still there.

The dentist then applies an adhesive that is primarily designed to penetrate and flow into the rough and open tooth anatomy while in an aqueous environment. This adhesive is then cured into a polymer by light or other means and establishes a chemical/physical bond to the prepared surface. For this reason adhesives have a low viscosity and ideally are able to flow. Next a viscous restorative composite is placed into the cavity and the treatment area filled and sculpted ideally back to the anatomy of the original tooth which is then cured/hardened/polymerized into place by light or other means. Finally the dentist will adjust any discrepancies in the anatomy usually on the occlusal surfaces to facilitate even biting surfaces followed by polishing the restoration for a better aesthetic look.

The majority of current etching formulations used by practitioners are inorganic acids that must be applied to the tooth structure and rinsed prior to the application of the adhesive. The most common etch is a 30%-40% phosphoric acid etch. Strong phosphoric acid is capable of etching all tooth structure including dentin and enamel. Dentin is a complex structure of mineralized collagen. Enamel on the other hand is almost entirely composed of mineralized rods. Dentin is much easier to effectively etch than enamel, which requires a more concentrated and higher pH acid to effectively etch. Current generation of rinse-able phosphoric acid etches effectively etch both enamel and dentin. There are even some phosphoric acid etches that incorporate an additional disinfectant into their formulations. The disadvantage to these inorganic etches is they must be applied and rinsed from the surface before application of the adhesive.

To improve upon these conventional phosphoric acid etches there have been introduced adhesives that require no additional etch on dentin. These incorporate organic acids in a pre-treatment application that is applied prior to a secondary adhesive step. The disadvantages to these self-etching adhesives are the requirement of additional steps other than the adhesive step and they do not etch enamel effectively. For example, self-etch primers require the etching of enamel margins with conventional phosphoric acid etches, which must be rinsed prior to the application of the organic acid conditioners. These current generation of restorative system thus require more than 2 steps in their applications and most require an etch step that must be rinsed.

Glutaraldehyde is a commonly used compound found everyday in many practitioners' offices. Glutaraldehyde performs both a desensitizing and a disinfection function all-in one application. Glutaraldehyde is a very aggressive sterilant and is toxic to both bacteria and tissue. It will not only kill bacteria on contact, but will also pickle nerve endings that cause post-operative chronic pain. Glutaraldehyde is not acidic and therefore is not an etching reagent. It is a useful pre-treatment option to aid in the long-term success of the restoration. A 5% solution of glutaraldehyde is commonly applied after etching and prior to the adhesive step.

Dentists for lack of time and increased efficiency many times will attempt to minimize the number of steps in a restoration procedure to the most practical levels. For this reason the non-essential treatment steps often get left out. These are usually the desensitizing and disinfection steps. These 2 steps are non-essential to the immediate restoration but are often times vital to the long-term success of the restoration. For example a dentist may complete a restoration without disinfecting and desensitizing to save time and send the patient home. If the tooth becomes sensitive and the residual caries continue to decay the tooth, the patient will be back for a second or third unpaid appointment; thereby increasing the time of restoration.

The present invention described below provides improved compositions that combine a desensitizer, disinfectant and etch into a single application that requires no rinsing. This aids the practitioner by performing all 3 functions in a single step, saving time and preserving the long-term viability of the restoration.

### SUMMARY OF THE INVENTION

The compositions of the present invention utilize a combination of select organic acids and glutaraldehyde as a means to disinfect, desensitize, and etch in a single step. The combination restorative tooth preparation and treatment composition comprises sufficient amount of an organic acid containing at least one or more carboxylic acid groups wherein the pH of the organic acid in aqueous solution is sufficient for tooth dentin and enamel etching. Added to this is a sufficient amount of glutaraldehyde for disinfection and desensitizing, and a solvent. The type of organic acid, the ratio of the organic acid to glutaraldehyde, and the solvent dilution are selected such that a one step etch, disinfection, and desensitizing composition is formed.

Organic acids of this invention are chemical compounds with one or more carboxylic acids (COOH) in its structure, which are capable of etching dentin and tooth enamel. Specifically, the compositions of the present invention are designed to etch both enamel and dentin in a single step with no rinsing required. This is achieved through the selection of organic acids, more specifically carboxylic acids with unusually low pH. These are carboxylic acids that achieve an incredibly low pH through the addition of electron withdrawing groups such as dihydroxyfumaric acid and trichloroacetic acid. There are also other organic acids that use bond strain to increase the acidity of the carboxylic acid such as squaric acid. Squaric acid, also called quadratic acid, because its four carbon atoms approximately form a square, is an organic compound with chemical formula C₄H₂O₄. It is one of the oxocarbonic acids (acids that have an oxocarbon anion as their conjugate base). Its structure is not a perfect square, as the carbon-carbon bond lengths are not quite equal. The high acidity with pKa=1.5 for the first proton and pKa=3.4 for the second is attributable to resonance stabilization of the anion. Because the negative charges are equally distributed between each oxygen atom, the dianion of squaric acid is completely symmetrical (unlike squaric acid itself) with all C—C and C—O bond lengths identical.

This invention uses any of the many organic acids available both commercially and capable of being made in the future that achieve an unusually low pH using electron withdrawing groups, bond strain, or other organic synthesis methods. The preferred composition of the present invention incorporates one or more of these unusually low pH organic acids with glutaraldehyde in an all inclusive single step treatment.

Specifically, the compositions of the present invention combine glutaraldehyde with a low pH organic acid such as trichloroacetic acid, fumaric acid, dihydroxy acetic acid, squaric acid and any other organic acid producing a pH under 3 in aqueous solution. Since the present invention is intended to be applied and not rinsed it is also important that the residual chemicals deposited on the tooth surface not interfere with the physical and chemical bonding of the adhesive. This is a critical function of the invention that it minimizes the interference between an un-rinsed disinfected and sterilized surface and conventional adhesives. This is accomplished as a general rule by minimization of all solutes in the solution to maximize the bond strength of the adhesive. Therefore the compositions that have the least amount of organic acids and glutaraldehyde have the least interference with the adhesive. The organic acid that can etch both dentin and enamel at the lowest concentration in solution is the most preferred.

A preferred composition of the present invention incorporates trichloracetic acid as the preferred organic acid since it can etch both enamel and dentin at concentrations of 1%-5% by weight. Some organic acids when combined with glutaraldehyde in solution will leave a residue that if left un-rinsed will interfere with the adhesive. Trichloroacetic acid in combination with 5% glutaraldehyde minimizes this interference with respect to all tested organic acids. The combination of a 1%-5% by weight trichloracetic acid and a 5% by weight glutaraldehyde in an aqueous solution creates a no rinse etch that is capable of etching both enamel and dentin as well as disinfecting and desensitizing the tooth.

Some examples of compositions (by weight percentages) of the invention that have varying degrees of etching, desensitizing and etching properties, are as follows:
Formula #1

1. 2% trichloroacetic acid

2. 5% glutaraldehyde

3. 93% water
Formula #2

1. 3% trichloroacetic acid

2. 5% glutaraldehyde

3. 92% water
Formula #3

1. 4% trichloroacetic acid

2. 5% glutaraldehyde

3. 91% water
Formula #4

1. 5% trichloroacetic acid

2. 5% glutaraldehyde

3. 90% water
Formula #5

1. 2% trichloroacetic acid

2. 7% glutaraldehyde

3. 91% water
Formula #6

1. 2% trichloroacetic acid

2. 3% glutaraldehyde

3. 95% water
Formula #7

1. 10% dihydroxy fumaric acid

2. 5% glutaraldehyde

3. 85% water
Formula #8

1. 2% dihydroxy fumaric acid

2. 5% glutaraldehyde

3. 93% water
Formula #9

1. 7% dihydroxy fumaric acid

2. 5% glutaraldehyde

3. 88% water
Formula #10

1. 10% trichloroacetic acid

2. 5% glutaraldehyde

3. 85% water
Formula #11

1. 10% squaric acid

2. 5% glutaraldehyde

3. 85% water
Formula #12

1. 2% squaric acid

2. 5% glutaraldehyde

3. 93% water
Formula #13

1. 6% squaric acid

2. 7% glutaraldehyde

3. 87% water
Formula #14

1. 3% squaric acid

2. 3% glutaraldehyde

3. 94% water

However, other compositions employing an organic acid with a pH in aqueous solution less than 3 with glutaraldehyde in varying amounts of solvent may be employed to provide the required physical handling characteristics required. Separate treatment compositions may be prepared and applied with different pH levels. This allows compositions with lower pH levels to be used to increase acid etching capability. For example, one preferred organic acid composition has a pH in aqueous solution less than 2. Another organic acid composition has a pH in aqueous solution less than 1. And for extremely strong etchings, the organic acid in aqueous solution has a pH of approximately zero. For example, a 3% trichloracetic acid in water has a pH of about zero.

The preferred organic acids for the combination restorative tooth preparation and treatment composition are selected from the group consisting of trichloroacetic acid, dihydroxy fumaric acid, and squaric acid.

Two preferred combination restorative tooth preparation and treatment compositions have glutaraldehyde concentrations greater than 5%, and greater than 1% by weight. The higher strength glutaraldehyde composition is used where increased disinfection is required.

The solvent part of the combination restorative tooth preparation and treatment composition is present in the largest amount. Different solvents may be employed, from water to an organic liquid such as ethanol, isopropyl alcohol, propylene glycol, glycerin, propanol, hexane, heptane, ocatane and any like solvent. The solvent may also combine water in combination with these organic liquid(s) such as ethanol, isopropyl alcohol, propylene glycol, glycerin, propanol, hexane, heptane, ocatane and any like solvent.

The method for producing the combination restorative tooth preparation and treatment composition comprises combining an organic acid containing at least one or more carboxylic acid groups that has a pH in water of less than 3 comprising 2% to 7% by weight of a composition with glutaraldehyde comprising greater than 1% by weight of the composition, and a solvent selected from the group consisting of water, organic liquid(s) such as ethanol, isopropyl alcohol, propylene glycol, glycerin, propanol, hexane, heptane, ocatane and any like solvent comprising 85% to 95% by weight of the composition. This solvent addition minimizes solute concentrations to reduce interference with adhesives. The organic acid and the ratio of the organic acid to glutaraldehyde are selected such that they do not deposit significant residual chemicals on tooth surfaces, which interfere with the physical and chemical bonding of an adhesive. Properly blended, the composition produces a bond strength not less than 50% those used on rinsed tooth surfaces; and has the desired shear strength, viscosity, and other physical properties. These ingredients are then mixed to form a uniform restorative tooth preparation and treatment composition for application. There is no particular order in which the ingredients are added, as there are no mixing reaction turning points. They are simply dumped together and mixed.

After mixing, the composition is tested to determine if it has the right physical properties, such as viscosity, shear, concentrations, test for impurities, etc. Preferred physical properties of the composition are those, which are liquid compositions with low surface tension to flow for good tooth surface penetration and coverage. Surfactants can also be added to lower surface tension.

If the right physical properties are not present, additional solvents or surfactants are added. The following are a list of the preferred surfactant additives: sodium lauryl sulfate, Polysorbates, Lauryl dimethyl amine oxide, Cetyltrimethylammonium bromide, Polyethoxylated alcohols, Polyoxyethylene sorbitan Octoxynol, N,N-dimethyldodecylamine-N-oxide, Hexadecyltrimethylammonium bromide, Polyoxyl 10 lauryl ether, Polyoxyl castor oil, Nonylphenol ethoxylate, Cyclodextrins, Lecithin, and Methylbenzethonium chloride.

The above examples should not be construed as limiting the scope of the invention but as merely providing illustrations of some of the presently preferred embodiments of this invention. Thus, the scope of the invention should be determined by the appended claims and their legal equivalents rather than by the examples given.

We claim:

1. A combination restorative tooth preparation and treatment composition comprising:
a. sufficient amount of an organic acid containing at least one or more carboxylic acid groups wherein the pH of the organic acid in aqueous solution is sufficient for tooth dentin and enamel etching,
b. sufficient amount of glutaraldehyde for disinfection and desensitizing, and
c. a solvent;
whereby the type of organic acid, the ratio of the organic acid to glutaraldehyde, and the solvent dilution are selected such that a one step etch, disinfection, and desensitizing composition is formed.

2. A combination restorative tooth preparation and treatment composition according to claim 1, wherein the organic acid the pH of the organic acid in aqueous solution is less than 3 and comprises 2% to 7% by weight of the composition, the glutaraldehyde comprises 3% to 5% by weight of the composition, and the solvent comprises 85% to 95% by weight of the composition to minimize solute interference with adhesive bonding producing an adhesive bonding strength not less than 50% of the bonding strength when used on rinsed tooth surfaces.

3. A combination restorative tooth preparation and treatment composition according to claim 1, wherein the organic acid is selected from the group consisting of trichloroacetic acid, dihydroxy fumaric acid, and squaric acid.

4. A combination restorative tooth preparation and treatment composition according to claim 1, wherein the solvent is water.

5. A combination restorative tooth preparation and treatment composition according to claim 1, wherein the solvent is an organic liquid solvent.

6. A combination restorative tooth preparation and treatment composition according to claim 5, wherein the organic liquid solvent is selected from the group consisting of ethanol, isopropyl alcohol, propylene glycol, glycerin, propanol, hexane, heptane, ocatane, and similar solvents.

7. A combination restorative tooth preparation and treatment composition according to claim 1, wherein the solvent is water in combination with an organic miscible liquid solvent(s) such as ethanol, isopropyl alcohol, propylene glycol, glycerin, propanol, hexane, heptane, ocatane, and any like solvent.

8. A combination restorative tooth preparation and treatment composition according to claim 1, wherein the glutaraldehyde concentration is greater than 5% by weight.

9. A combination restorative tooth preparation and treatment composition according to claim 1, wherein the glutaraldehyde concentration is greater than 1% by weight.

10. A combination restorative tooth preparation and treatment composition according to claim 1, wherein the pH of the organic acid is aqueous solution is less than 3.

11. A combination restorative tooth preparation and treatment composition according to claim 1, wherein the pH of the organic acid is aqueous solution is less than 2.

12. A combination restorative tooth preparation and treatment composition according to claim 1, wherein the pH of the organic acid in aqueous solution is less than 1.

13. A combination restorative tooth preparation and treatment composition according to claim 1, wherein the pH of the organic acid in aqueous solution is approximately 0.

14. A combination restorative tooth preparation and treatment composition according to claim 1, wherein the pH of the organic acid in aqueous solution is greater than approximately 3.

15. A combination restorative tooth preparation and treatment composition comprising:
a. sufficient amount of an organic acid containing at least one or more carboxylic acid groups wherein the pH of the organic acid in aqueous solution is sufficient for tooth dentin and enamel etching,
b. sufficient amount of glutaraldehyde for disinfection and desensitizing, and
c. sufficient amount of a solvent to reduce solute interference with adhesive bonding producing an adhesive bonding strength not less than 50% of the bonding strength when used on rinsed tooth surfaces;
whereby the type of organic acid, the ratio of the organic acid to glutaraldehyde, and the solvent dilution are selected such that a one step etch, disinfection, and desensitizing composition is formed.

16. A combination restorative tooth preparation and treatment composition comprising:
a. an organic acid selected from the group consisting of trichloroacetic acid, dihydroxy fumaric acid, and squaric acid comprising 2% to 7% by weight of the composition,
b. glutaraldehyde comprising greater than 1% by weight of the composition, and
c. a solvent selected from the group consisting of water, organic liquid(s) such as ethanol, isopropyl alcohol, propylene glycol, glycerin, propanol, hexane, heptane, ocatane and any like solvent comprising 85% to 95% by weight of the composition to reduce solute interference with adhesives producing an adhesive bonding strength not less than 50% of the bonding strength when used on rinsed tooth surfaces; whereby the type of organic acid, the ratio of the organic acid to glutaraldehyde, and the solvent dilution are selected such that a one step etch, disinfection, and desensitizing composition is formed, which doesn't require rinsing and deposits residual chemicals on tooth surfaces at levels, which don't significantly interfere with the physical and chemical bonding of an adhesive.

17. A method for producing a combination restorative tooth preparation and treatment composition comprising:
a. combining
i. sufficient amount of an organic acid containing at least one or more carboxylic acid groups wherein the pH of the organic acid in aqueous solution is sufficient for tooth dentin and enamel etching,
ii. sufficient amount of glutaraldehyde for disinfection and desensitizing, and
iii. a solvent;
whereby the type of organic acid, the ratio of the organic acid to glutaraldehyde, and the solvent dilution are selected such that a one step etch, disinfection, and desensitizing composition is formed; and
b. mixing the composition to form a uniform restorative tooth preparation and treatment composition.

18. A method for producing a combination restorative tooth preparation and treatment composition comprising:
a. combining
i. an organic acid containing at least one or more carboxylic acid groups wherein the pH of the organic acid in aqueous solution is less than 3 comprising 2% to 7% by weight of the composition,
ii. glutaraldehyde comprising greater than 1% by weight of the composition, and
iii. a solvent selected from the group consisting of water, organic liquid(s) such as ethanol, isopropyl alcohol, propylene glycol, glycerin, propanol, hexane, heptane, ocatane and any like solvent comprising 85% to 97% by weight of the composition to reduce solute interference with adhesives producing an adhesive bonding strength not less than 50% of the bonding strength when used on rinsed tooth surfaces; whereby the type of organic acid, the ratio of the organic acid to glutaraldehyde, and the solvent dilution are selected such that a one step etch, disinfection, and desensitizing composition is formed, which doesn't require rinsing and deposits residual chemicals on tooth surfaces, which minimize interference with the physical and chemical bonding of an adhesive, and
b. mixing the composition to form a uniform restorative tooth preparation and treatment composition.

19. A method for producing a combination restorative tooth preparation and treatment composition according to claim 18, including testing the restorative tooth preparation and treatment composition to determine if it has desired viscosity, shear, and physical characteristics, and adjusting the percent composition of organic acid, glutaraldehyde, and solvent to meet the desired physical characteristics.

20. A method for producing a combination restorative tooth preparation and treatment composition according to claim 18, wherein the composition is a liquid with low surface tension to flow for good tooth surface penetration and coverage.

21. A method for producing a combination restorative tooth preparation and treatment composition according to claim 20, including the addition of surfactants to lower surface tension.
